(19) United States
(12) Patent Application Publication
(10) Pub. No.: US 2025/0192444 A1
(43) Pub. Date: Jun. 12, 2025

(54) ELECTROMAGNETIC WAVE REFLECTING DEVICE AND ELECTROMAGNETIC WAVE REFLECTING FENCE

(71) Applicant: AGC Inc., Tokyo (JP)

(72) Inventor: Kumiko KAMBARA, Tokyo (JP)

(73) Assignee: AGC Inc., Tokyo (JP)

(21) Appl. No.: 19/054,233

(22) Filed: Feb. 14, 2025

Related U.S. Application Data
(63) Continuation of application No. PCT/JP2023/030700, filed on Aug. 25, 2023.

(30) Foreign Application Priority Data
Sep. 2, 2022 (JP) 2022-140096

(51) Int. Cl. H01Q 15/14

(52) U.S. Cl. CPC H01Q 15/14

(57) ABSTRACT

An electromagnetic wave reflecting device includes a reflective panel having a reflective surface configured to reflect an electromagnetic wave of a predetermined frequency band of 1 GHz or more and 300 GHz or less; a frame configured to hold the reflective panel; and a leg portion configured to support the frame, wherein a movable part is provided and configured to adjust a position or an angle of the reflective panel with respect to an incident electromagnetic wave, and wherein the leg portion extends in a direction intersecting the reflective surface of the reflective panel.

### CROSS-REFERENCE TO RELATED APPLICATIONS

This application is continuation of a International Application PCT/JP2023/030700, filed on Aug. 25, 2023 and designated the U.S., which is based on and claims priority to Japanese patent application No. 2022-140096 filed on Sep. 2, 2022, with the Japan Patent Office. The entire contents of these applications are incorporated herein by reference.

### BACKGROUND OF THE INVENTION

### 1. Field of the Invention

The present disclosure relates to an electromagnetic wave reflecting device and an electromagnetic wave reflecting fence.

### 2. Description of the Related Art

In a fifth-generation mobile communication system (hereinafter referred to as “5G”), while high-speed and large-capacity communication is expected, there can be places that radio waves have trouble reaching, due to radio waves with strong rectilinearity being used. In a next-generation 6G mobile communication system, expansion to the sub-terahertz band is expected. In places where there are many metal machines, such as in a factory, or places where there are many reflections from walls or roadside trees, such as in a block of buildings, a means for delivering radio waves to the target terminal device or radio equipment is required. There is a similar demand in places where NLOS (Non-Line-Of Sight) spots, i.e. spots from which there is no line of sight to the base station antenna, occur, such as medical facilities, event venues, and large commercial facilities.

Recently, reflective surfaces with artificial surfaces called “metasurfaces” have been developed. A metasurface is formed of structures or patterns with sub-wavelength periodicity, and is designed to reflect radio waves in a desired direction. Since a metasurface can realize a desired reflection angle without having its planar arrangement changed, it can be effectively used as a reflector even in an environment where there is no space to install many specular reflectors. A configuration in which electromagnetic wave reflecting devices are arranged along at least a part of a manufacturing line has been proposed (For example, see International Publication WO 2021/199504). Generally, the larger the reflector size, the larger the gain, and the reflection efficiency and propagation environment can be improved by using a larger reflector. However, metasurface reflectors require microfabrication to form a structure or pattern smaller than the wavelength of 5G or 6G radio waves, and many of them have a side size of about 150 mm to 500 mm. The power reflection efficiency of metasurface reflectors varies depending on the angles of incidence and reflection, and the power reflection efficiency tends to decrease when the reflection angle for normal incidence is 70° or more. In a design to keep the power reflection efficiency of a metasurface constant, there is a limitation that the range of the reflection angle for normal incidence must be between −60° and +60°. Even when a metasurface reflector is used, if the installation location is restricted or the layout of the installation location is frequently changed, the reflector itself may need to be moved.

On the other hand, a reflector using specular reflection has a high degree of freedom in the material selection for the conductive layer, which is a functional layer, and has few size restrictions, so it is easy to fabricate a reflector with a large area. A specular reflector has good reflection characteristics and is expected to improve the propagation environment sufficiently. However, due to the positional relationship with the base station, the direction of reflection is fixed to regular reflection, in which the reflection angle is equal to the incident angle, and the reflection angle cannot be controlled. When a specular reflector is used, it is necessary to adjust the installation position and angle according to the position of the base station, and the position adjustment is more important than for a metasurface reflector. In a large reflector in which a reflective panel having a side size of 1.0 m or more is held by a frame, it is difficult to move and adjust the angle of the reflector.

One object of the present disclosure is to provide an electromagnetic wave reflecting device in which the position or angle of the reflective panel with respect to an incident electromagnetic wave can be easily adjusted.

### SUMMARY OF THE INVENTION

In one embodiment, provided is an electromagnetic wave reflecting device including: a reflective panel having a reflective surface configured to reflect an electromagnetic wave of a predetermined frequency band of 1 GHz or more and 300 GHz or less; a frame configured to hold the reflective panel; and a leg portion configured to support the frame, wherein a movable part is provided and configured to adjust a position or an angle of the reflective panel with respect to an incident electromagnetic wave, and wherein the leg portion extends in a direction intersecting the reflective surface of the reflective panel.

Provided is an electromagnetic wave reflecting device in which the position or angle of the reflective panel with respect to an incident electromagnetic wave can be easily adjusted.

### BRIEF DESCRIPTION OF THE DRAWINGS

FIG. 1 is a schematic diagram of an electromagnetic wave reflecting fence using an electromagnetic wave reflecting device of a first embodiment;

FIG. 2 is a horizontal cross-sectional view of a frame holding a reflective panel;

FIG. 3A is a schematic view of a pendulum test;

FIG. 3B is a schematic view of a pendulum test;

FIG. 4A is a diagram showing a state of a leg portion of examples;

FIG. 4B is a diagram showing a state of a leg portion of reference examples;

FIG. 5 is a schematic view of an electromagnetic wave reflecting device of a second embodiment;

FIG. 6 is a schematic view of an electromagnetic wave reflecting fence obtained by connecting the electromagnetic wave reflecting devices of FIG. 5 to each other;

FIG. 7A is a perspective view of an electromagnetic wave reflecting device of a third embodiment;

FIG. 7B is a top view of the electromagnetic wave reflecting device of the third embodiment;

FIG. 8 is a schematic view of a movable part of the electromagnetic wave reflecting device of FIGS. 7A and 7B; and

FIG. 9 is a diagram showing a layout of a space of an indoor facility.

### DESCRIPTION OF THE PREFERRED EMBODIMENTS

The specific configuration of the electromagnetic wave reflecting device and the electromagnetic wave reflecting fence will be described below with reference to the drawings. The following embodiments are examples for embodying the technical concept of the present disclosure and are not intended to limit the present disclosure. The sizes and positional relationships of the members shown in the drawings may be exaggerated in order to facilitate understanding of the invention. The same component or function may be given the same name or reference numeral, and redundant explanations may be omitted.

### First Embodiment

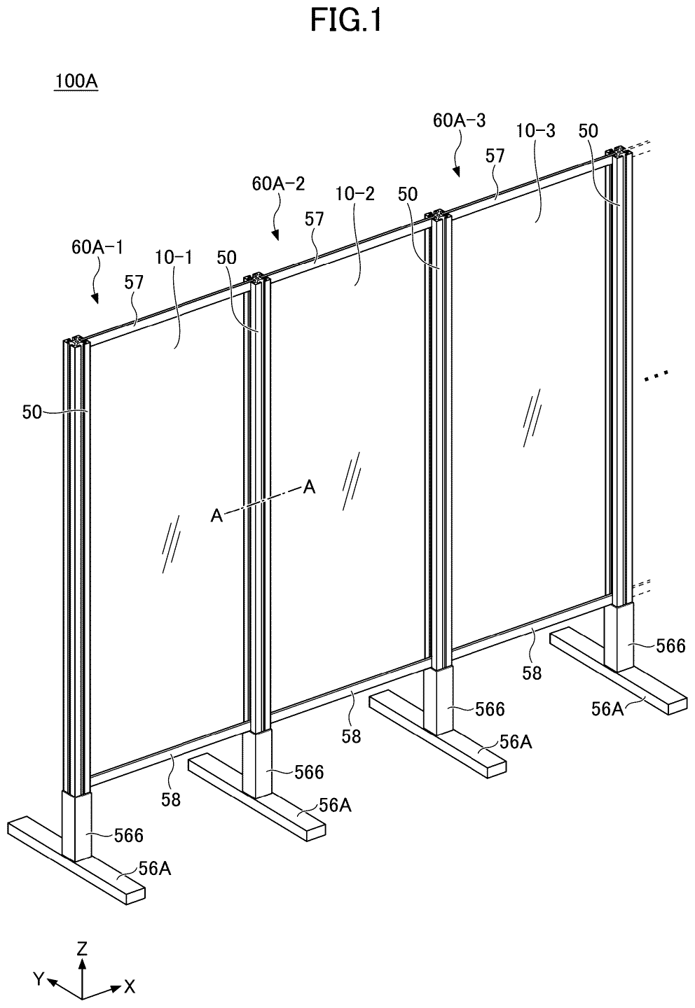

FIG. 1 is a schematic diagram of an electromagnetic wave reflecting fence 100A using electromagnetic wave reflecting devices 60A-1, 60A-2, and 60A-3 of a first embodiment. The electromagnetic wave reflecting devices 60A-1, 60A-2, and 60A-3 (hereinafter referred to in general as “electromagnetic wave reflecting devices 60A” as appropriate) respectively have reflective panels 10-1, 10-2, and 10-3 (hereinafter referred to in general as “reflective panels 10” as appropriate), which each have a reflective surface. The reflective surface of a reflective panel 10 may be either a specular reflector or a metasurface, or may include both. Each electromagnetic wave reflecting device 60 has a frame 50 for holding the reflective panel 10, a leg portion 56A for supporting the frame 50, and a movable part enabling adjustment of the position or angle of the reflective panel with respect to an incident electromagnetic wave. In the first embodiment, the leg portion 56A that is removable from the frame 50 is used as the movable part. The leg portion 56A extends in a direction intersecting the reflective surface of the reflective panel 10, for example, in a direction substantially perpendicular to the reflective panel 10.

In the coordinate system of FIG. 1, the plane on which the electromagnetic wave reflecting device 60A or the electromagnetic wave reflecting fence 100A is installed is an XY plane, and a height direction orthogonal to the XY plane is the Z direction. A width direction of the reflective panel 10 is the X direction, and a thickness direction of the reflective panel 10 is the Y direction. When the electromagnetic wave reflecting device 60A is in an upright position, the reflective panel 10 is in the XZ plane, and the leg portion 56A extends in the Y direction. When the leg portion 56A extends in the “perpendicular direction” relative to the reflective panel 10, it does not mean that the leg portion 56A and the reflective panel 10 form an angle of exactly 90°, and it is assumed this includes an angle range of 90°±20°, taking into account manufacturing errors and assembly convenience.

By configuring the leg portion 56A to be removable from the frame 50 and to extend in the direction perpendicular to the reflective panel 10, the reflective panel 10 can be stably supported at a desired position and at a desired angle even when the electromagnetic wave reflecting device 60 is moved. For example, a socket 566 protruding in the height direction (Z direction) may be provided in the central portion of the leg portion 56A, and the frame 50 may be received by the socket 566. When supporting a large reflective panel 10, a certain degree of strength and stability is required for the leg portion 56A, but by extending the leg portion 56A in a direction intersecting the reflective panel 10, preferably in a direction substantially perpendicular to the reflective panel 10, and supporting the frame 50 with the socket 566, the frame can sufficiently withstand an impact test described later.

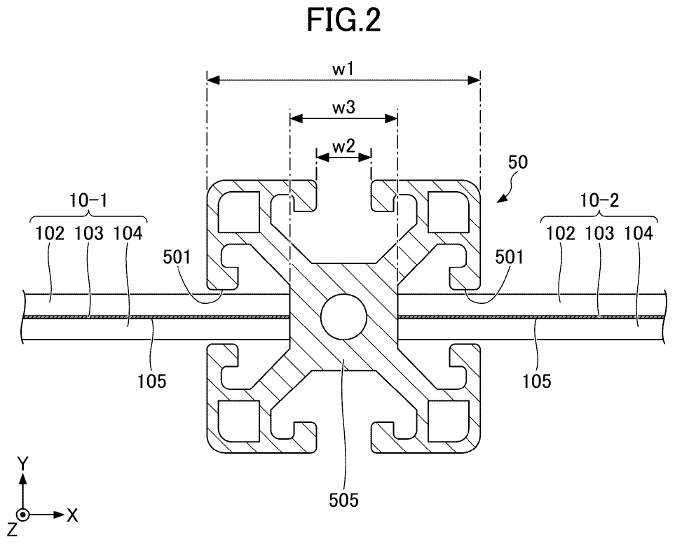

FIG. 2 is a horizontal cross-sectional view taken along line A-A of FIG. 1. This horizontal cross-sectional view shows an example of a configuration of the frame 50 in a plane parallel to the XY plane. The frame 50 has a body 505 formed of a conductor such as aluminum and a slit 501 formed in the body 505. Reflective panels 10-1 and 10-2 are inserted and held in the slit 501 of the frame 50. The frame 50 is shaped to reduce the volume of the body 505 to achieve weight reduction, but is not limited to the shape shown in FIG. 2, as long as the adjacent reflective panels 10-1 and 10-2 can be held. The frame 50 having the horizontal cross-sectional shape of FIG. 2 can be formed by injection molding, for example.

In the configuration example of FIG. 2, the outline of the horizontal cross-sectional shape of the frame 50 is substantially square, and is shaped to be substantially symmetrical with respect to the center of the body 505. The frame 50 may be used in any orientation. A width w1 corresponding to the length of one side of the horizontal cross section of the frame 50 is about 40 mm to 60 mm. A width w2 of the slit 501 is determined by the thickness of the reflective panels 10-1 and 10-2. A thickness w3 of the central portion of the body 505 is set in a range of 15 mm to 35 mm according to the strength required for the frame 50. A central shaft may be provided at the center of the body 505 of the frame 50. The outer surface of the frame 50 may be covered with an insulating cover made of resin or the like.

The reflective panels 10-1 and 10-2 each have a conductive layer 103 and dielectric layers 102 and 104 between which the conductive layer 103 is arranged. The conductive layer 103 is formed of a metal material that reflects an electromagnetic wave of a predetermined frequency band within a range of 1 GHz or more and 300 GHz or less, or 1 GHz or more and 170 GHz or less, for example, an electromagnetic wave of a frequency band used in 5G, and has a reflective surface formed of a metal pattern such as a circle, polygon, rectangle, or mesh shape. All of the conductive layer 103 may be a specular surface, a metasurface, or a mixture of both. The dielectric layers 102 and 104 are transparent to visible light and to the frequency of the electromagnetic wave to be reflected. In consideration of the electromagnetic wave reflecting device 60 being used indoors, outdoors, in a factory, at a manufacturing site, etc., it is desirable that the dielectric layers 102 and 104 have a strength sufficient to withstand the impact of a person, a tool, and the like. For example, optical plastic, reinforced plastic, reinforced glass, etc. having a predetermined strength may be used. As the optical plastic, polycarbonate (PC), polymethylmethacrylate (PMMA), polystyrene (PS), or the like may be used.

Depending on the incident direction of the electromagnetic wave, the interface between the conductive layer 103 and the dielectric layer 102, or the interface between the conductive layer 103 and the dielectric layer 104, becomes the reflective surface 105. In a case where the conductive layer 103 of the reflective panel 10 held by the frame 50 is a specular reflective surface, the conductive layer 103 is connected to the body 505 inside the frame 50. As a result, the reflective panels 10-1 and 10-2 are electrically connected, and the potential of reflection continues between the adjacent reflective panels 10. In a case where the reflective surface is a metasurface, there is no need for electrical connection between the adjacent reflective panels 10.

Referring back to FIG. 1, in addition to the frames 50 for holding the side edges of the reflective panel 10, a top frame 57 and a bottom frame 58 may be provided for holding the upper and lower ends of the reflective panel 10, respectively. By using the top frame 57 and the bottom frame 58, the entire circumference of the edge of the reflective panel 10 is held, thereby improving the strength and stability of the electromagnetic wave reflecting device 60. The lower end of the frame 50 is removably supported by the leg portions 56A. As described above, the leg portions 56A extend in a direction intersecting the reflective surface of the reflective panel 10, preferably in a direction substantially perpendicular thereto, thereby stably supporting the reflective panel 10. By individually moving the leg portions 56A to determine the position and orientation of the reflective panel 10, and inserting the frame 50 holding the reflective panel 10 into the leg portions 56A, the electromagnetic wave reflecting device 60 can be installed at a desired position and at a desired angle. After the position of the electromagnetic wave reflecting device 60 and the angle of the reflective panel 10 are determined, a lock mechanism for releasably locking the leg portions 56A with respect to the installation surface may be used.

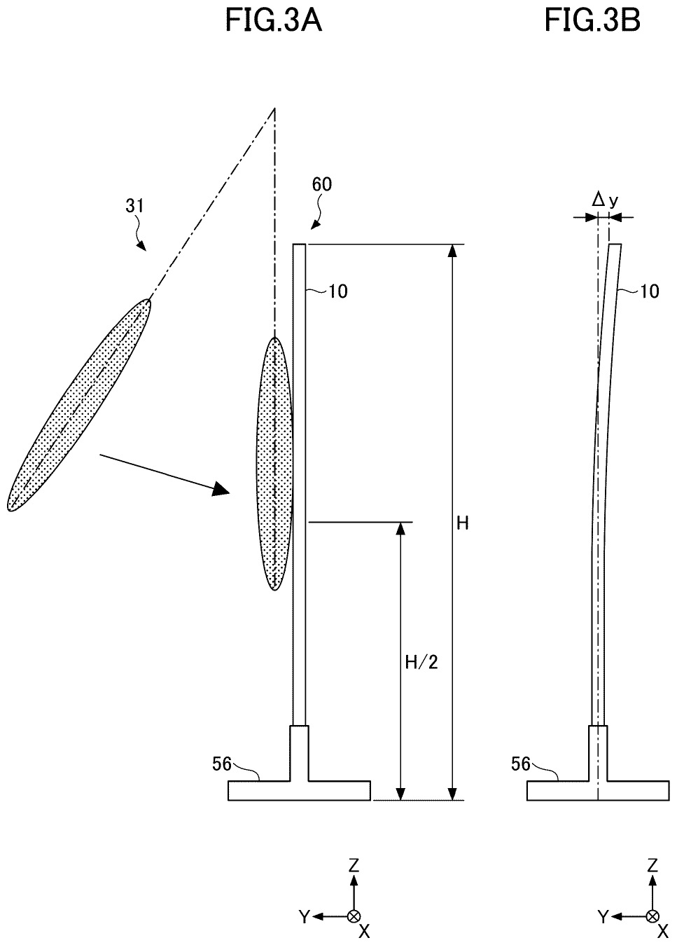

FIGS. 3A and 3B are schematic diagrams of a pendulum test for testing the strength and stability of the leg portion 56A. This pendulum test is a pendulum impact test in accordance with ISO (International Organization for Standardization) 14120. As shown in FIG. 3A, the height of the center point of the impact of a soft pendulum 31 is set to half (H/2) the height H of the electromagnetic wave 60. When of reflecting device the height H the electromagnetic wave reflecting device 60 is 2,200 mm, the height of the striking point is 1,100 mm. The weight of the soft pendulum 31 is 90 kg, and the impact load energy E is 115 J.

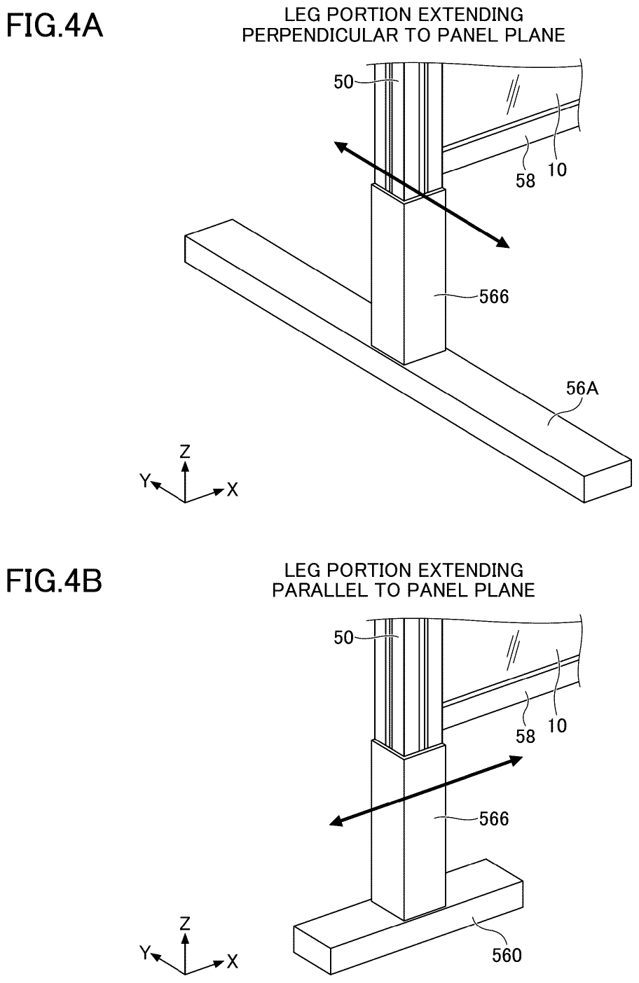

As shown in FIGS. 3A and 3B, the reflective panel before being struck in an is upright position perpendicular to the XY plane, which is the installation plane, and is parallel to the XZ plane. The strain or deformation of the struck reflective panel 10 in the Y (thickness) direction from the XZ plane is measured as the permanent deformation amount Δy. The strength and stability of the leg portion 56 are evaluated by how much the reflective panel 10 is deformed in the Y direction by the impact of the soft pendulum 31. As shown in FIG. 4A, the leg portion 56A of first extends the embodiment in the direction perpendicular to the reflective panel 10. As a reference example, FIG. 4B shows an electromagnetic wave reflecting device using a leg portion 560 extending in parallel with the reflective panel 10. A pendulum test is also performed on the structure of this reference example.

The evaluation results of the structures of the Examples and the structures of the reference examples are shown below. The reference examples are examples used for the purpose of facilitating understanding of the present disclosure and are not examples of related art. Example 1 and Example 2 are the evaluation results of the embodiment using the leg portion 56A shown in FIG. 4A, and Example 3 and Example 4 are the evaluation results when the leg portion 560 of the reference example shown in FIG. 4B is used.

### Example 1

Two polycarbonate sheets, each having a length of 2.0 m, a width of 1.0 m, and a thickness of 2.0 mm, are used as the dielectric layers 102 and 104 of the reflective panel 10. A stainless steel mesh having a thickness of 100 μm is located between the two polycarbonate sheets as a conductive layer 103. An ethylene vinyl acetate layer having a thickness of 400 μm is inserted as an adhesive layer between the stainless steel mesh and each polycarbonate sheet. The side edges of the reflective panel 10 are held by aluminum frames 50 having a height of 2,200 mm. The central portion of the body 505 of the frame 50 has a thickness of 15 mm. The central portion of the body 505 has a thickness corresponding to the width w3 in FIG. 2. The frame 50 is fixed to the reflective panel via a bracket using M5 bolts and nuts. The outer surface of the frame 50 is covered with a vinyl chloride cover. The upper and lower ends of the reflective panel 10 are respectively held by a top frame 57 and a bottom frame 58 that each have a length of 1, 100 mm in the X direction and a thickness of 15 mm. The top frame 57 and the bottom frame 58 are fixed to the reflective panel 10 using a bracket, bolts, and nuts.

An iron leg portion 56A having a length of 1,200 mm is used as the leg portion 56A supporting the reflective panel 10. The frame 50 is inserted into the socket 566 that projects in the height (Z) direction from the center of the leg portion 56A, and the reflective panel 10 is erected so that the leg portion 56A extends in a direction substantially perpendicular to the reflective panel 10. The leg portion 56A extends 600 mm from the center of the socket 566 in the front-rear direction of the reflective panel 10. As shown in FIG. 1, three reflective panels 10 are connected by the frames 50, and each reflective panel 10 is supported by leg portions 56A extending in a direction perpendicular to the reflective panel 10. For the purpose of the pendulum test, each leg portion 56A is fixed to the installation surface by an interlock-type guard.

In accordance with the pendulum test according to ISO 14120 shown in FIGS. 3A and 3B, in a state where three reflective panels 10 are connected, the central reflective panel 10 is impacted by the soft pendulum 31. The impact load energy E is set to 115 J, and the central reflective panel is struck by the soft pendulum 31 with a weight of 90 kg. The permanent deformation Δy of the struck reflective panel in the Y direction was 0.0 mm, and no distortion, flaw, penetration, crack or the like occurred in the reflective panel 10. It has been confirmed that sufficient stability and strength can be obtained for the electromagnetic wave reflecting device 60 by using the leg portions 56A extending in a direction substantially perpendicular to the reflective panel 10.

### Example 2

In Example 2, the same conditions as in Example 1 are used, except that the length of each leg portion 56A supporting the reflective panel 10 was changed to 1,000 mm. The layer structure of the reflective panel 10 is the same as in Example 1. A polycarbonate sheet with a thickness of 2.0 mm is attached to each side of a stainless steel mesh having a thickness of 100 μm, with an adhesive layer of ethylene vinyl acetate having a thickness of 400 μm interposed therebetween. The reflective panel 10 has length and width sizes of 2.0 m×1.0 m. The side edges of the reflective panel 10 are held by aluminum frames 50 having the same height of 2, 200 mm as in Example 1 and a thickness (corresponding to the width w3 in FIG. 2) of 15 mm at the center of the body 505, and are fixed to the reflective panel with brackets using M5 bolts and nuts. The outer surface of the frame 50 is covered with a vinyl chloride sheet. The upper and lower ends of the reflective panel 10 are held respectively by a top frame 57 and a bottom frame 58 that each have a length of 1,100 mm in the X direction and a thickness of 15 mm, and are fixed with brackets using bolts and nuts.

The frame 50 is inserted into the socket 566 protruding in the height (Z) direction from the center of the leg portion 56A, and the reflective panel 10 is erected so that the leg portion 56A extends in a direction substantially perpendicular to the reflective panel 10. The leg portion 56A extends 500 mm from the center of the socket 566 in each of a front direction and a rear direction of the reflective panel 10. As shown in FIG. 1, the pendulum test according to ISO 14120 shown in FIGS. 3A and 3B is performed by connecting three reflective panels 10 with the frames 50, in the same manner as in Example 1. The impact load energy E is 115 J, and the weight of the soft pendulum 31 is 90 kg. The permanent deformation amount Δy of the reflective panel in the Y direction is 0.0 mm, and the reflective panel 10 is free from distortion, flaws, penetration, cracks, and the like. Even when a leg portion 56A shorter than that in Example 1 was used, it was confirmed that the leg portion 56A extending in a direction substantially perpendicular to the reflective panel 10 could be used to withstand the same impact, and that sufficient stability and strength could be obtained for the electromagnetic wave reflecting device 60.

### Example 3

Example 3 is a reference example, and the leg portion 560 shown in FIG. 4B is used. The leg portion 560 extends in a direction parallel to the reflective surface of the reflective panel 10. The layer structure and size of the reflective panel 10 are the same as those of Example 1 and Example 2. Frames 50, a top frame 57, and a bottom frame 58 having the same structures as those of Example 1 and Example 2 hold the entire circumference of the reflective panel 10, and the lower end of each frame 50 is inserted into the socket of an iron leg portion 560. The leg portion 560 of the reference example extends in a direction parallel to the reflective panel 10.

The length of the leg portion 560 is 150 mm on each side, from the center of the slot, and 300 mm in total. As shown in FIG. 1, three reflective panels 10 are connected by the frames 50, and the central reflective panel is impacted in a pendulum test according to ISO 14120 shown in FIGS. 3A and 3B. For the purpose of the pendulum test, each leg portion 560 is fixed to the installation surface by an interlock-type guard. The impact load energy E is 115 J, and the weight of the soft pendulum 31 is 90 kg. The permanent deformation amount Δy of the reflective panel 10 in the Y direction is 200 mm. The reflective panel 10 did not have any scratches or cracks, but there was a problem that the reflective panel was partially detached due to the deformation of the frame 50. Even when the leg portions 560 are fixed to the installation surface, if the leg portions 560 extend in parallel with the reflective panel 10, it can be seen that the strength and stability against impact are insufficient.

### Example 4

Example 4 is a reference example, and the leg portion 560 shown in FIG. 4B is used. The same conditions as in Example 3 are used, except that the weight of the soft pendulum 31 in the pendulum test is changed to 120 kg. The leg portion 560 is a 300 mm long iron leg portion extending in a direction parallel to the reflective surface of the reflective panel 10. The layer structure and size of the reflective panel 10 supported by the leg portions 560 are the same as those in Example 1, Example 2, and Example 3. The leg portions 560 are fixed to the installation surface by an interlock-type guard for the purpose of the pendulum test.

As shown in FIG. 1, three reflective panels 10 are connected by the frames 50, and the central reflective panel is impacted in the pendulum test according to ISO 14120 using the soft pendulum 31 having a weight of 120 kg. The permanent deformation amount Δy of the reflective panel 10 in the Y direction was 500 mm. Although the reflective panel 10 was not scratched or cracked by the impact, there was a problem that the reflective panel 10 was partially detached due to the deformation of the frame 50. It can be seen that even when the leg portions 560 are fixed to the installation surface, if the leg portions 560 extend in parallel with the reflective panel 10, the distortion and deformation of the electromagnetic wave reflecting device become remarkable when the impact becomes large.

As described above, in the first embodiment, the removable leg portion 56A extending in a direction intersecting the reflective surface 105 of the reflective panel 10, preferably in a direction substantially perpendicular to the reflective surface 105, is used as the movable part. With this configuration, the strength and stability of the electromagnetic wave reflecting device 60 and the electromagnetic reflecting fence 100A are enhanced, and the installation positions and installation angles of the electromagnetic wave reflecting device 60 and the electromagnetic wave reflecting fence 100A can be easily changed. The length of the leg portion 56A is set so that the reflective panel 10 can be stably supported in accordance with the weight of the leg portion 56A and the weight of the reflective panel 10 to be supported. In the case where the reflective panel 10 that is 2.0 m×1.0 m is held by the lightweight frame 50 made of aluminum and supported by the leg portion 56A made of iron, as in the Examples, the length of the leg portion 56A may be determined in a range of 50 mm or more to 2,000 mm or less.

### Second Embodiment

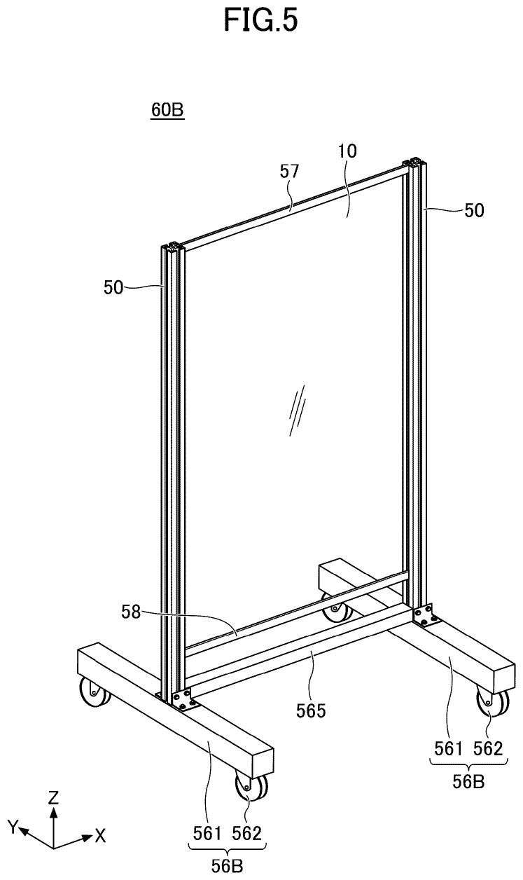

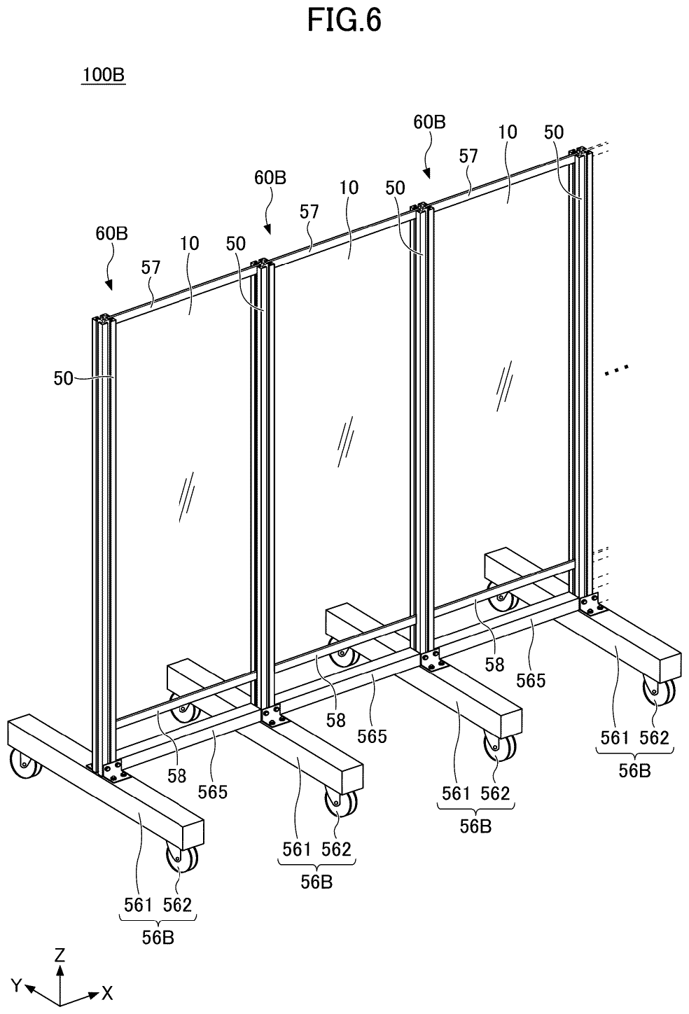

FIG. 5 is a schematic view of an electromagnetic wave reflecting device 60B of the second embodiment, and FIG. 6 is a schematic view of an electromagnetic wave reflecting fence 100B in which electromagnetic wave reflecting devices 60B of FIG. 5 are connected in the lateral direction. In the second embodiment, a leg portion 56B with casters is used as the movable part. The structures of the reflective panel 10, the frame 50, the top frame 57, and the bottom frame 58 are the same as in the first embodiment.

The frame 50 is fixed to the leg portion 56B using, for example, an L-shaped bracket, bolts, and nuts. The leg portion 56B has a leg portion body 561 extending in a direction intersecting the reflective surface 105 (see FIG. 2) of the reflective panel 10, preferably in a direction perpendicular to the reflective surface 105, and casters 562 attached to the leg portion body 561. The casters 562 are provided, for example, at or near the longitudinal ends of the leg portion body 561.

The electromagnetic wave reflecting device 60B may be transported to the installation site with the leg portion 56B attached thereto, or the leg portion 56B may be transported separately from the reflective panel 10 and the frame 50, and assembled at the installation site. After the frame 50 is fixed to the leg portion 56B at the installation site, the electromagnetic wave reflecting device 60B may be moved using the casters 562 of the leg portion 56B to determined or adjust the installation position and the orientation of the reflective panel 10 at the installation site.

By using the leg portion 56B with the casters 562, the installation position of the electromagnetic wave reflecting device 60B and the angle of the reflective panel can be flexibly adjusted according to the positional relationship with the base station. The casters 562 may be casters 562 with a locking function. In this case, after the installation position of the electromagnetic wave reflecting device 60B and the orientation of the reflective panel 10 are determined, the electromagnetic wave reflecting device 60B can be fixed at this position. When the electromagnetic wave reflecting device 60B is to be moved to another place or the orientation of the reflective panel 10 is to be changed, the casters 562 are unlocked, and the electromagnetic wave reflecting device 60B is moved or oriented simply by lightly pushing it.

Two leg portions 56B supporting the frames 50 on respective sides of the reflective panel 10 may be connected by a beam 565. The beam 565 extends parallel to the transverse direction of the reflective panel 10 at substantially the centers of the leg portions 56B in the longitudinal axis direction. Although t the beam 565 is not essential, by providing the beam 565, the positional relationship between the leg portions 56B forming a pair is fixed, and the mechanical strength and stability of the leg portions 56B are improved.

### Third Embodiment

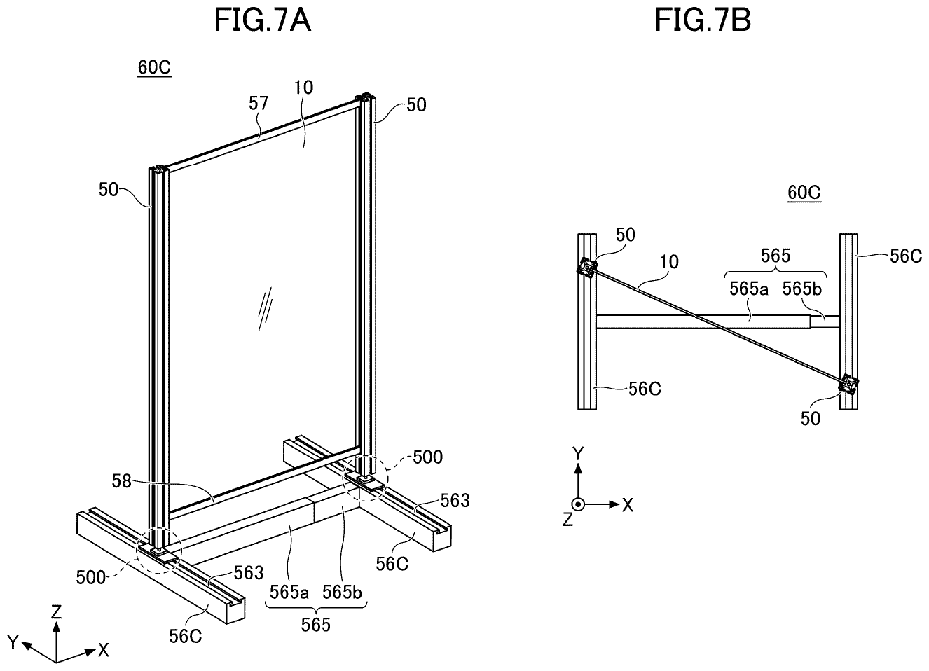

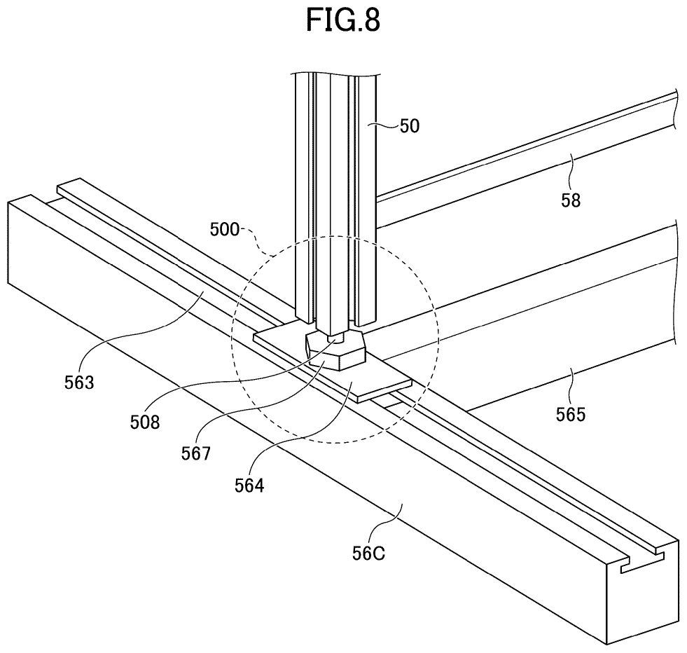

FIGS. 7A and 7B are schematic views of an electromagnetic wave reflecting device 600 of the third embodiment, and FIG. 8 is an enlarged view of a movable part 500 of the electromagnetic wave reflecting device 60C of FIGS. 7A and 7B. In the third embodiment, the frame 50 for holding the reflective panel 10 is held to be movable relative to a leg portion 56C. In the coordinate systems of FIGS. 7A and 7B, the installation surface of the electromagnetic wave reflecting device 60C is the XY plane, the length direction of the leg portion 56C in the XY plane is the Y direction, and the height direction of the electromagnetic wave reflecting device 60 is the Z direction.

FIG. 7A is a perspective view of the electromagnetic wave reflecting device 60C, and FIG. 7B is a top view of the electromagnetic wave reflecting device 60C. The electromagnetic wave reflecting device 60C includes the reflective having a reflective surface for reflecting electromagnetic waves, a frame 50C for holding the reflective panel 10, the leg portion 56C for supporting the frame, and the movable part 500 for adjusting the angle or position of the reflective panel 10 with respect to the incident electromagnetic wave. The movable part 500 is provided at a connection portion between the leg portion 56C and the frame 50C.

As shown in the enlarged view of FIG. 8, the movable part 500 includes a rail 563 formed on the leg portion 56C, a slider 564 slidable on the rail 563, and a bearing 567 provided on the slider 564. The bearing 567 rotatably receives a central shaft 508 of the body 505 (see FIG. 2) of the frame 50.

As shown in FIG. 7A, in the default state of the electromagnetic wave reflecting device 60C, the leg portion 56C extends in a direction perpendicular to the reflective panel 10, and the reflective panel 10 is held substantially in the center of the longitudinal axis direction of the leg portion 56C and substantially parallel to the XZ plane by the frame 50. When it is desired to move the reflective panel forward or backward along the Y axis, the position of the reflective panel 10 in the Y direction can be changed by moving the slider 564 along the rail 563. When the length of the leg portion 56C is 1,000 mm, the position of the reflective panel 10 in the Y direction can be moved forward and backward by 0.5 m from the default position, such that the position in the Y direction can be changed within a total range of 1.0 m.

When it is desired to change the orientation or angle of the reflective panel 10, if the change is to be within a range of several degrees with respect to the X-axis, the angle of the reflective panel 10 can be changed by rotating the frame 50 around the Z-axis. When it is desired to make a greater change to the angle of the reflective panel 10, as shown in FIG. 7B, the frames 50 is rotated around the Z-axis while the sliders 564 are moved along the Y-axis in opposite directions from each other by the pair of leg portions 56C. At this time, since the distance between the leg portions 56C forming the pair changes, the length of the beam 565 connecting the pair of leg portions 56C is made variable. The length changing mechanism of the beam 565 can adopt any configuration that allows the beam 565 to extend and contract, such as fitting a first portion 565a of the beam 565 into a second portion 565b so as to be slidable, or connecting the first portion 565a and the second portion 565b with an elastic member.

The configuration of the third embodiment is useful because the position and orientation of the reflective panel can be changed within a certain range after the electromagnetic wave reflecting device 60C is fixed to the installation surface. In some cases, after the electromagnetic wave reflecting device 60C is initially installed, new equipment or structures are introduced into the installation site and the radio wave propagation environment changes. In such a case, the radio wave propagation state can be improved by finely adjusting the position or angle of the reflective panel 10. By using the electromagnetic wave reflecting device 60B with the casters 562 as in the second embodiment, changes in the environment after the electromagnetic wave reflecting device is installed can be easily coped with. However, depending on the installation site, it may be desirable to fix the leg portions to the installation surface with anchor brackets or the like. According to the configuration of the third embodiment, the position and orientation of the reflective panel 10 can be easily adjusted without removing the anchor brackets. When it is desired to greatly change the installation position of the electromagnetic wave reflecting device 60C itself, the configuration of the second embodiment can be adopted as well to provide casters 562 with locking functions on the leg portions 56C.

The electromagnetic wave reflecting devices 60C can be connected as shown in FIG. 1. For example, when three reflective panels 10 are connected by the frames 50, movable parts 500 are provided at the connection portions between the respective frames 50 and the corresponding leg portions 56C. The electromagnetic wave reflecting fence 100 was actually assembled by connecting three reflective panels that are 2.0 m in length and 1.0 m in width, used in Example 1 and Example 2, with the frames 50. The reflective panel 10 is formed by bonding a polycarbonate sheet that is 2.0 mm in thickness to both surfaces of a conductive layer 103 of mesh that is 100 μm in thickness, with an adhesive layer of ethylene vinyl acetate that is 400 μm in thickness interposed therebetween. The central shaft 508 is inserted into a through-hole in the center of the body 505 of the frame 50 shown in FIG. 2, and the central shaft is inserted into the bearing 567. When the sliders 564 were slid in the Y direction while the frames 50 were rotated around the Z axis, all three reflective panels 10 could be inclined to +5° with respect to the X axis.

### <Evaluation of Effect of Improving Radio Wave Environment>

The first embodiment, the second embodiment, and the third embodiment described above can be combined with each other. For example, casters 562 may be attached to the removable leg portions 56A of the first embodiment. In Example 5 and Example 6 below, the electromagnetic wave reflecting device 60 provided with casters 562 on the leg portions 56A of the first embodiment was introduced into an indoor facility, the received power thereof was measured, and the effect of the embodiment was evaluated. As a reference example, the effect of improving the radio wave environment realized by an electromagnetic wave reflecting device that does not use leg portions was evaluated in Example 7 and Example 8. Since leg portions are not used, the frame 50 of the electromagnetic wave reflecting device is directly fixed to the installation surface using an L-shaped anchor bracket extending in a direction parallel to the reflective panel.

### Example 5

A panel frame is assembled in which the side edges of a reflective panel 10, which has the same layer structure as in Example 1 and Example 2, a length of 1.0 m, a width of 2.0 m, and a thickness of 5.0 mm, are held by aluminum frames 50, each having a length of 2200 mm and a thickness (w3) of 15 mm at the center of the body 505, and by a top frame 57 and a bottom frame 58 each having a length of 2, 200 mm and a thickness of 15 mm. The electromagnetic wave reflecting device is assembled in an indoor facility by inserting each frame 50 into a socket 566 of an iron leg portion 56 having casters 562. The length of the iron leg portion is 1,000 mm, and a caster 562 is provided near each end of the bottom surface of the leg portion. The height of the top frame 57 of the reflective panel 10 is about 2.15 m, and the height of the bottom frame 58 is about 0.15 m.

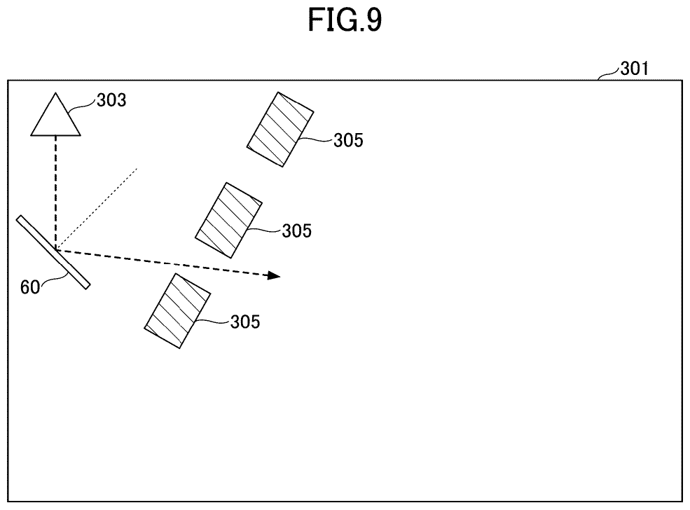

FIG. 9 shows the layout of the space 301 of the indoor facility. The size of the space 301 is 25.0 m in length, 50.0 m in width, and 5.0 m in height. A transmitting antenna of a base station 303 is located at a corner of the space 301 at a height of 2.5 m. A plurality of metal racks 305 are installed in the space 301, creating a dead zone behind the metal racks 305 as seen from the base station 303. The plurality of metal racks 305, which are each 2.5 m in length, 0.5 m in width, and 1.5 m in height, are arranged in a row at a position diagonally below and 10.0 m away, in a linear distance, from the transmitting antenna of the base station that is at a height of 2.5 m.

The received power was measured in an area around the base station 303 and in an area of 5 m² located behind the row of metal racks 305 as seen from the base station antenna. The received power in the area surrounding the base station 303 is −70 dBm. In the area behind the row of metal racks 305, the received power range is in a range of −150 dBm to −100 dBm, forming a dead zone. In this dead zone, in the downlink, the reception rate is 30 Mbps while the transmission rate is 50 Mbps. In the uplink, the reception rate is 7 Mbps while the transmission rate is 15 Mbps.

The received power in the dead zone was measured while the electromagnetic wave reflecting device 60 was moved using the casters 562, and the optimum position and angle of the electromagnetic wave reflecting device 60 were set so that the received power in the dead zone would be maximized. As a result, the received power in the dead zone improved from −100 dBm to −70 dBm when the electromagnetic wave reflecting device was installed at a position about 5.0 m away from the base station and with an orientation whereby the angle of incidence of the electromagnetic wave radiated from the base station antenna to the reflective panel was 45°. With this arrangement, the reception rate recovered to 50 Mbps for the transmission rate of 50 Mbps in the downlink, and the reception rate recovered to 15 Mbps for the transmission rate of 15 Mbps in the uplink.

### Example 6

The layout is changed in the space 301 of the same indoor facility as in Example 5. In fact, the layout is often changed in indoor facilities such as factories, and autonomous robots, wearable terminals, and the like are introduced, resulting in use cases requiring 5G radio waves. As a result of the layout change, a plurality of metal racks 305, each having a length of 5.0 m, a width of 0.5 m, and a height of 1.5 m, are arranged in a row at a position 15.0 m away, in a linear distance, from the transmitting antenna of the same base station. The radio wave propagation environment in an area of 10 m² behind the row of metal racks as seen from the base station 303 is improved by using the electromagnetic wave reflecting device.

The received power in the dead zone of 10 m² was measured while the electromagnetic wave reflecting device 60 was moved using casters 562, and the optimum position and angle of the electromagnetic wave reflecting devices were set so that the received power in the dead zone was maximized. The electromagnetic wave reflecting device 60 with casters 562 can be easily moved by one adult, and can be moved from the installation position determined in Example 5 to the vicinity of the new measurement position in about 2 minutes. As a result of the measurement, the received power in the dead zone was improved from −100 dBm to −80 dBm when the electromagnetic wave reflecting device was installed at a position about 7.5 m away from the base station and with an orientation whereby the angle of incidence of the electromagnetic wave radiated from the base station antenna to the reflective panel becomes 45°. With this arrangement, the reception rate recovered to 50 Mbps for the transmission rate of 50 Mbps in the downlink, and the reception rate recovered to 15 Mbps for the transmission rate of 15 Mbps in the uplink.

### Example 7

Example 7 is a reference example. In Example 7, the effect of improving the radio wave environment is evaluated using an electromagnetic wave reflecting device without leg portions. The layer structure and size of the reflective panel 10 are the same as those of Example 5 and Example 6. The reflective panel having a length of 1.0 m, a width of 2.0 m, and a thickness of 5.0 mm is held by aluminum frames 50, a top frame 57, and a bottom frame 58 that are the same as those of Example 5 and Example 6. Three reflective panels are connected by the frames 50, and both sides of each frame 50 are directly fixed to the installation surface through L-shaped anchor brackets extending in a direction parallel to the reflective panel 10. The length of the portion of each L-shaped anchor bracket extending in a direction parallel to the reflective panel 10 is 150 mm, so that the length on both sides of the frame 50 combined is 300 mm.

The electromagnetic wave reflecting device of Example 7 is installed in the space 301 having a length of 25.0 m, a width of 50.0 m, and a height of 5.0 m, as in Example 5. The position of the transmitting antenna of the base station and the layout in the space 301 are the same as in Example 5. The received power in the area around the base station 303 is −70 dBm, while the received power in the area behind the metal racks 305 is from −150 dBm to −100 dBm, thus forming a dead zone. In the dead zone, in the downlink, the reception rate is 30 Mbps while the transmission rate is 50 Mbps, and in the uplink, the reception rate is 7 Mbps while the transmission rate is 15 Mbps.

The electromagnetic wave reflecting device of Example 7 is installed at the same position and the same angle as determined in Example 5. Since the electromagnetic wave reflecting device of Example 7 does not have a movable part, the reception power cannot be measured while moving the electromagnetic wave reflecting device. Therefore, the electromagnetic wave reflecting device of Example 7 is installed at the optimum position obtained in Example 5. The reflective panels 10 are erected, and both sides of each frame 50 are held by L-shaped anchor brackets extending in the direction parallel to the reflective panel, and fixed directly to the installation surface. The L-shaped anchor brackets are used as substitutes for the leg portions. With the electromagnetic wave reflecting device fixed to the installation surface by the L-shaped anchor brackets extending in parallel with the reflective surface, it was visually observed that the upper end of the reflective panels was inclined by about 5° with respect to the normal of the installation surface. The stability in the direction perpendicular to the reflective panel 10 (Y direction) is worsened by fixing the electromagnetic wave reflecting device with the L-shaped anchor brackets extending in the direction parallel to the reflective panel 10. By introducing the electromagnetic wave reflecting device of Example 7, the received power in the dead zone increased from −100 dBm to −95 dBm. In the dead zone, in the downlink, the reception rate is 35 Mbps transmission rate is 50 Mbps, and in the uplink, the reception rate is 7 Mbps while the transmission rate is Mbps.

Even though the electromagnetic wave reflecting device is installed in the same position as in Example 5, since the panel plane of the reflective panel is tilted, the angle of incidence and reflection of the electromagnetic wave changes, and radio waves cannot be effectively delivered to the dead zone. It can be seen that the electromagnetic wave reflecting device supported by leg portions, or alternatively L-shaped anchor brackets, extending in the direction parallel to the reflective panel does not provide sufficient strength and stability, and it is difficult to improve the radio wave propagation environment.

### Example 8

Example 8 is a reference example. In Example 8, as in Example 6, the received power is measured in the space 301 after the layout change. The electromagnetic wave reflecting device installed in Example 7 was disassembled once by four adults, and reassembled at the same optimum position of the electromagnetic wave reflecting device and with the same angle as determined in Example 6. Disassembly and assembly took three hours in total. Even after reassembly, it was visually confirmed that the upper end of the reflective panel held by the top frame 57 was inclined by about 5° from the normal of the installation surface.

The received power in the dead zone behind the metal racks 305 placed according to the same layout change as in Example 6 remains at −100 dBm. Despite the installation of the electromagnetic wave reflecting device of Example 8, the received power in the dead zone does not improve. In the dead zone, in the downlink, the reception rate is 30 Mbps while the transmission rate is 50 Mbps, and in the uplink, the reception rate is 7 Mbps while the transmission rate is Mbps. It has been reconfirmed that the electromagnetic wave reflecting device supported by leg portions, or alternatively L-shaped anchor brackets, extending in the direction parallel to the reflective panel does not provide sufficient strength and stability, and as a result, it is difficult to improve the radio wave propagation environment.

Although the present disclosure has been described based on specific examples, the present disclosure cannot be limited to the above-described configuration examples. As the movable part, any configuration can be adopted in which at least one of the position and the angle of the reflective panel can be changed. The configuration by which the reflective panel 10 is moved in the longitudinal direction of the leg portion is not limited to the rail 563 and the slider 564, and a configuration using a wire and a pulley, a stepwise feeding mechanism, or the like may be used. The plane size of the reflective panel 10 of the movable electromagnetic wave reflecting device 60 can be designed according to the application situation, and as an example, a size from 0.7 m×0.7 m to 2.0 m×4.0 m can be used. Even such a large reflective panel can have its position or angle easily adjusted by using a movable member.

The present disclosure described above may include the following configurations.

### (Item 1)

An electromagnetic wave reflecting device comprising:
a reflective panel having a reflective surface configured to reflect an electromagnetic wave of a predetermined frequency band of 1 GHz or more and 300 GHz or less;
a frame configured to hold the reflective panel; and
a leg portion configured to support the frame,
wherein a movable part is provided and configured to adjust a position or an angle of the reflective panel with respect to an incident electromagnetic wave, and
wherein the leg portion extends in a direction intersecting the reflective surface of the reflective panel.

### (Item 2)

The electromagnetic wave reflecting device according to Item 1, wherein the leg portion has a socket for removably receiving the frame, and the movable part is the leg portion that removably supports the frame with the socket.

### (Item 3)

The electromagnetic wave reflecting device according to Item 1 or 2, wherein the leg portion includes a caster, and the movable part is the leg portion including the caster.

### (Item 4)

The electromagnetic wave reflecting device according to Item 2, wherein a caster is provided on a bottom surface of the leg portion having the socket.

### (Item 5)

The electromagnetic wave reflecting device according to Item 1, wherein the movable part moves the frame along a longitudinal axis of the leg portion.

### (Item 6)

The electromagnetic wave reflecting device according to Item 5, wherein the movable part includes a rail, formed on the leg portion, and a slider configured to be connected to the frame and to move along the rail.

### (Item 7)

The electromagnetic wave reflecting device according to Item 6, wherein the slider has a bearing configured to rotatably receive a central shaft of the frame.

### (Item 8)

The electromagnetic wave reflecting device according to Item 7, wherein
the frame includes a pair of frames holding edges on respective sides of the reflective panel,
the leg portion includes a pair of leg portions respectively supporting the frames of the pair of frames, and
the leg portions of the pair of leg portions are connected to each other by an extendable and contractible beam that extends in a direction parallel to the reflective panel.

### (Item 9)

The electromagnetic wave reflecting device according to any one of Items 1 to 8, wherein the leg portion extends in a direction perpendicular to the reflective surface of the reflective panel.

### (Item 10)

An electromagnetic wave reflecting fence including a plurality of said electromagnetic wave reflecting devices of any one of Items 1 to 9 connected to each other by the frame.

What is claimed is:

1. An electromagnetic wave reflecting device comprising:
a reflective panel having a reflective surface configured to reflect an electromagnetic wave of a predetermined frequency band of 1 GHz or more and 300 GHz or less;
a frame configured to hold the reflective panel; and
a leg portion configured to support the frame,
wherein a movable part is provided and configured to adjust a position or an angle of the reflective panel with respect to an incident electromagnetic wave, and
wherein the leg portion extends in a direction intersecting the reflective surface of the reflective panel.

2. The electromagnetic wave reflecting device according to claim 1, wherein the leg portion has a socket configured to removably receive the frame, and the movable part is the leg portion that removably supports the frame with the socket.

3. The electromagnetic wave reflecting device according to claim 1, wherein the leg portion includes a caster, and the movable part is the leg portion including the caster.

4. The electromagnetic wave reflecting device according to claim 2, wherein a caster is provided on a bottom surface of the leg portion having the socket.

5. The electromagnetic wave reflecting device according to claim 1, wherein the movable part moves the frame along a longitudinal axis of the leg portion.

6. The electromagnetic wave reflecting device according to claim 5, wherein the movable part includes a rail, formed on the leg portion, and a slider configured to be connected to the frame and to move along the rail.

7. The electromagnetic wave reflecting device according to claim 6, wherein the slider has a bearing configured to rotatably receive a central shaft of the frame.

8. The electromagnetic wave reflecting device according to claim 7, wherein
the frame includes a pair of frames holding edges on respective sides of the reflective panel,
the leg portion includes a pair of leg portions respectively supporting the frames of the pair of frames, and
the leg portions of the pair of leg portions are connected to each other by an extendable and contractible beam that extends in a direction parallel to the reflective panel.

9. The electromagnetic wave reflecting device according to claim 1, wherein the leg portion extends in a direction perpendicular to the reflective surface of the reflective panel.

10. An electromagnetic wave reflecting fence comprising a plurality of said electromagnetic wave reflecting devices of claim 1 connected to each other by the frame.
